(19) United States
(12) Patent Application Publication
(10) Pub. No.: US 2018/0015836 A1
(43) Pub. Date: Jan. 18, 2018

(54) System for Automatically Connecting a Parked Vehicle to a Power Source, Using Intersecting Lines of Contacts

(71) Applicant: Bezan Phiroz Madon, Old Bridge, NJ (US)

(72) Inventor: Bezan Phiroz Madon, Old Bridge, NJ (US)

(21) Appl. No.: 15/212,256

(22) Filed: Jul. 17, 2016

(51) Int. Cl. B60L 11/18

(52) U.S. Cl. CPC B60L 11/1827; B60L 11/1862; B60L 11/1846; B60L 11/1848; B60L 11/1818; B60L 2230/12; B60Y 2200/91; B60Y 2200/92

(57) ABSTRACT

Owning an electrically-powered vehicle or plug-in hybrid requires the owner to plug the vehicle into an electrical outlet every so often in order to re-charge the battery. Present methods to eliminate this chore have shortcomings. A typical robotic arm used has multiple servo motors for manipulation in 3 dimensions and rely on a camera and image processing for sensory inputs, making the system costly and error-prone. Or, the driver is required to dock the vehicle. The invention herein greatly simplifies the system by relying on a power source supplying an in-ground line of contacts and a pantograph, which is at right angles to this line, being lowered from the vehicle onto it. The two lines intersect at some point. Electronic signals sent through the contacts enable the power source subsystem to provide a charging voltage to the appropriate contact, thus completing a vehicle battery-charging circuit.

### BACKGROUND FOR THE INVENTION

Plug-in hybrids and other types of electric vehicles that rely on battery power are limited in travel-range by the amount of energy that can be stored by the battery. The vehicle owner has to frequently enact the chore of plugging the vehicle's electrical power cord into an electrical outlet. Multiple systems have been proposed for eliminating this chore. These related art systems require elements that cause them to be inordinately expensive, unreliable, or necessitating structures that would greatly diminish their practicality, as described below.

### DESCRIPTION OF RELATED ART

U.S. Pat. No. 799,506 describes a system wherein a structure behind the vehicle provides a robotic arm at the end of which is an electrical plug. The arm is maneuvered in three dimensions, and is guided with the help of a camera and image-processing software, so that the plug is guided into the battery-charging socket at the back of the vehicle. This approach has the following difficulties:
The robotic system, comprising at least 3 servo motors, a latching mechanism that locks the plug into the socket (U.S. Pat. No. 8,025,526), lighting, a camera, and sophisticated image processing software, is expensive.
The system relies on feed-back from image processing of a complex scene to position the plug exactly on the charger-socket of the automobile. This software requires artificial intelligence, which can be a hit-or-miss affair. Cases in point are: new vehicle body designs which may not be analyzable by the software, or dents or lighting tricks which may deceive the software.
The system requires a supporting structure that rises up vertically from the ground. Such a system is unlikely to find wide deployment in public parking lots, which are designed to be unobstructed spaces.

U.S. Pat. No. 8,718,856 describes a charger that requires the driver to maneuver the vehicle into a docking station. This partially defeats the purpose of an automated charger, since the chore for the vehicle operator is simply moved: from having to physically insert a plug into a socket, to having to engage in some difficult and potentially risky maneuvering. In order to be truly automatic, the system must not require the driver to alter in any way his or her current behavior of parking an unequipped vehicle in an ordinary parking spot.

U.S. Pat. No. 5,498,948 and U.S. Pat. No. 5,703,461 talk about transferring power to the vehicle through inductive coupling. For this to work well, the primary coil has to be extremely close to the secondary coil and share the same ferromagnetic core, as, for example, in a transformer. Otherwise, the power transfer is very inefficient, mitigating the usefulness of owning an electric vehicle, where the goal is to incur a lower carbon foot-print.

My invention provides a set of unobvious innovations for an automated charging system that give it the following characteristics:
The system is automatic and transparent. It does not require the driver to alter in any way his or her current behavior of parking an unequipped vehicle in an ordinary parking spot.
It requires minimal physical changes to the current infrastructure of parking spots. In particular, it does not require vertical charging station or docking structures, which would impede the maneuvering of vehicles in a public parking lot, which needs to be unobstructed.
It is low-cost, obviating the need for complex robotics.
It is 100% efficient in transferring power from the charger to the vehicle.
It is safe: When the power-source contacts are exposed, they do not have any voltage on them.
It is weather-proof.

### SUMMARY OF THE INVENTION

When a vehicle is parked in a ‘designated parking spot’, the system that is the subject of this invention accomplishes the task of automatically causing contacts from a battery-charging circuit in the vehicle to find and create an electrical connection with a power source in the designated parking spot. The system has a set of desirable characteristics, listed at the bottom of this section, that are not achievable with a straight-forward application of the prior art.

The system consists of two subsystems: a ‘vehicle subsystem’ that is built into the vehicle (1-1), and a ‘power-source subsystem’ that is built into a designated parking spot (1-2). Each subsystem is independently controlled by a microprocessor.

The vehicle subsystem includes a ‘pantograph’ (1-3), supported horizontally underneath the vehicle. This is a 2 to 4 feet strip of insulated backing, along which are arranged pairs of contacts. With respect to the vehicle's battery-charging circuit, one contact in each pair has a ‘positive’ electric polarity, and the other has a ‘negative’ polarity. When the vehicle is not actively charging from a power source, the pantograph is retracted underneath the vehicle.

The power source subsystem is contained in a 2 to 4 feet-long ‘power-strip’, embedded almost-flush with the ground in the designated parking spot (1-2). Arranged along the power-strip is a set of single contacts. In the quiescent state of the system, the power-strip contacts do not carry any voltage.

The orientation of the pantograph, suspended underneath the vehicle, is at right angles to the orientation of the power-strip in the designated parking spot.

When the driver parks the vehicle in the designated parking spot, the vehicle subsystem is triggered to attempt to make a connection with a power source subsystem by the vehicle's main power switch (commonly, the ‘ignition key’ (1-13)) being turned from the ‘on’ to the ‘off’ position.

The vehicle subsystem sends out an exploratory ‘wireless request signal’ from a low-power ‘radio-frequency identification (RFID)’ device. A matching RFID device in the power source subsystem responds. On receiving the response, the vehicle subsystem is able to determine that it is parked in a designated parking spot.

The vehicle subsystem lowers its pantograph to the ground, causing it to touch the power-strip (which is at right angles to it) at an intersection point. The contact dimensions are such that each pantograph contact touches one or two power-strip contacts.

The vehicle subsystem now sends a low-voltage, high-frequency digital ‘wired request signal’ through each pantograph contact. By testing for reception of the wired request signal, the power source subsystem determines the one or two power strip contacts touching the positive pantograph contact. Data encoded over the wired request signal is used to authenticate the vehicle subsystem to the power source subsystem. Alternatively, if the designated parking spot is public, the vehicle subsystem may pass payment information, such as a credit card number.

On authentication or approval, the power source subsystem completes a battery-charging circuit for the vehicle subsystem by connecting one of the power strip contacts touching a positive pantograph contact to an AC live of DC positive charging voltage, and connecting the one or two power-strip contacts touching a negative pantograph contact to ground.

In order to continue receiving a charging voltage from the power source subsystem, the vehicle subsystem must repeatedly send a request key over the wired request signal. When the vehicle's battery is fully-charged or when the vehicle's power switch is turned from the ‘off’ to the ‘on’ position, the vehicle subsystem determines that it needs to disconnect. It retracts the pantograph. The stream of request keys from the vehicle subsystem is interrupted. Immediately, the power source subsystem disconnects the positive charging voltage provided to its positive contact. All the power source system contacts are now disconnected and are safe to step on. The charging cycle is complete.

The system is automatic and transparent, because it does not require the driver to dock the vehicle into a power receptacle, nor to take any overt action that differs from parking an ordinary vehicle in an ordinary parking spot.

The power source subsystem is embedded almost-flush into the ground and has no vertical obstructions.

The system is low-cost and reliable. The three or more servo motors of a typical robotic arm, capable of moving in three dimensions, are reduced to one. The need for a latching mechanism to lock a plug into a charging socket is obviated. The need to use feedback from a camera and image processing software, which may be unreliable in anomalous situations (e.g. a dented fender) is obviated.

The connection is close to 100% efficient in transferring power, since it relies on physical contact between electrodes rather than electromagnetic coupling. The system is safe from accidentally shocking a person or animal: a contact of the power source subsystem is only provided a power voltage as long as the repeated request key encoded over the wired request signal is being continuously recognized by the power-strip electronics.

The system is weather-proof: The wired request signal is shorted and is impossible to send when the designated parking spot is flooded or under water.

### BRIEF DESCRIPTION OF THE DRAWINGS

FIG. 1 is an elevation drawing showing an overview of the system, and illustrating the vehicle subsystem and the power source subsystem, in the preferred embodiment.

FIG. 2 is a plan drawing showing an overview of the system. It also shows the ‘allowable area’ (2-4), a large rectangle within which the vehicle may be parked anywhere for the system to work.

FIG. 3 shows a bottom-up view of the pantograph at the end of the robotic arms in the preferred embodiment with a view of the pantograph contacts touching the power-strip contacts.

FIG. 4 shows a cross-sectional view of the pantograph lowered onto the power-strip.

FIG. 5 is a sectional view, showing each of the pantograph contacts touching a unique power-strip contact. FIG. 5a is the same sectional view in a configuration where the positive pantograph contact touches two power-strip contacts.

FIG. 6 is a side view of the pantograph in its retracted position underneath the vehicle.

FIG. 7 shows the circuit board, which is the vehicle subsystem controller.

FIG. 8 is a cross-sectional view of the pantograph and the power-strip, with a pantograph contact touching a power-strip contact.

FIG. 8a is a similar cross-sectional view of the negative pantograph contacts, showing them connected to vehicle ground.

FIG. 9 is a flow-chart of the controlling software in the microprocessor of the vehicle subsystem.

FIG. 10 is a sectional view, showing how each “switch” integrated circuit in the power-strip can alternately connect a power-strip contact to an AC live or a DC positive charging voltage or ground.

FIG. 11 is a flow-chart of the controlling software in the microprocessor of the power source subsystem.

FIG. 12 shows an alternate embodiment with a 3-D motion robotic arm instead of intersecting lines of contacts. However, it still uses the other innovations herein, such as the wireless request signal and the wired request signal.

FIG. 13 shows an alternate embodiment in which the orientations of the pantograph and the power strip are reversed.

### DETAILED DESCRIPTION OF A PREFERRED EMBODIMENT OF THE INVENTION

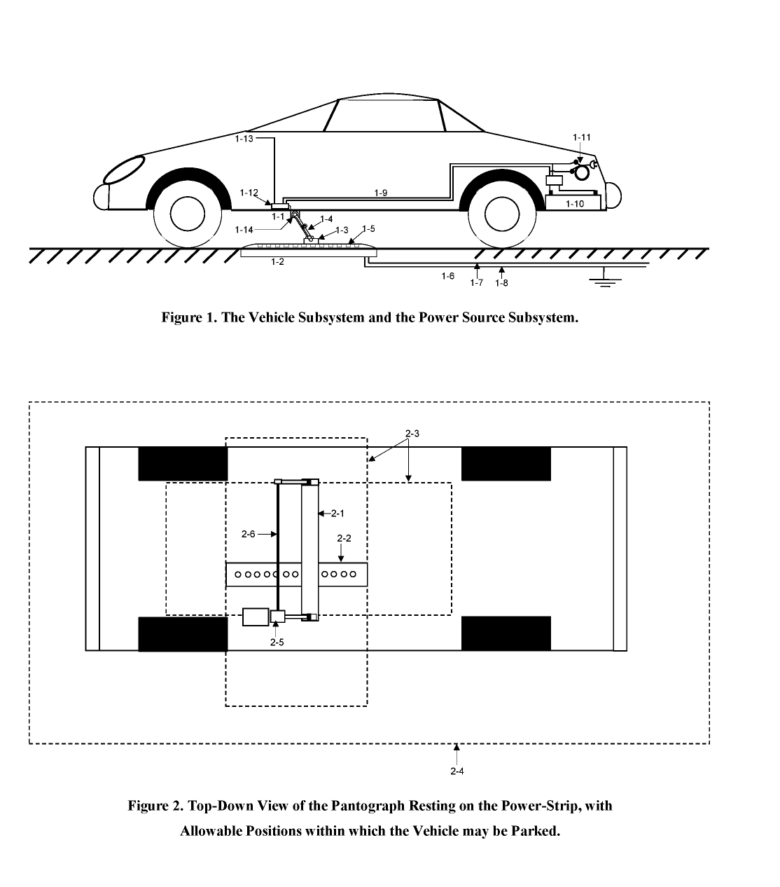

FIG. 1 shows an overview of a preferred embodiment of the system that is the subject of this invention. It consists of: a ‘vehicle subsystem’ (1-1) on the vehicle, and a ‘power source subsystem’ (1-2) which is embedded into the ground in the middle of a designated parking spot.

The vehicle subsystem includes a 2-4 feet long ‘pantograph’ (1-3) supported horizontally at the end of two robotic arms underneath the vehicle (1-4). The pantograph is made up of a strip of insulated backing with pairs of contacts arranged along its length. When the vehicle is charging, current flows from the power source subsystem through a contact-pair in the pantograph, through a pair of wires strung along one of the robotic arm, into the battery-charging circuit in the vehicle (1-9), and thence to the battery (1-10). A traditional power cord and plug (1-11) are also provided in the vehicle, as backup for occasions when the vehicle is not parked in a designated parking spot and needs to be plugged in in the traditional manner. The vehicle subsystem is controlled by a microprocessor and electronics in a controller box (1-12). This receives a digital input signal (1-13) from the vehicle's power switch indicating whether the vehicle's power switch is in the “on” or “off” position.

The power source subsystem consists primarily of a ‘power-strip’. This is a 2-4 feet long slab, made of some strong material, embedded into the ground in the middle of the designated parking spot. The top surface of the power-strip emerges about ½ inch above the ground and is rounded, so that the whole resembles a very small speed bump. Embedded into the power-strip, along the top are a series of electrical contacts (1-5). The power-strip encases an electronic circuit board that controls when the electrical contacts are connected to the leads of a power supply. The power supply is brought to the power-strip via an underground cable (1-6). The power supply may be alternating current (AC) or direct current (DC) and must have a voltage that matches the needs of the battery-charging circuit in the vehicle. In the rest of this document we refer to the AC live or DC positive lead of the power supply as the ‘positive power supply lead’ (1-7). We refer to the AC ground or DC negative lead of the power supply as the ‘negative power supply lead’(1-8). The negative power supply lead is typically grounded. The outer casing of the power-strip is made of concrete or some other material with high compression strength, such, that the wheel of a full-sized vehicle may drive over it without causing damage. The power-strip is a sealed unit, and the strip and the underground cable together are water-proof.

The driver parks the vehicle in the designated parking spot, taking no action that is different from parking an unequipped vehicle in an ordinary parking spot. When the vehicle's power switch is turned “off”, a low-power radio-frequency identification (RFID) transmitter in the controller box is triggered to send out a ‘wireless request signal’. On receiving this signal, a matching RFID device in the power source subsystem responds with an acknowledgement. Both RFID devices have a very short range that only needs to span the distance from the bottom of the vehicle to the ground.

The vehicle subsystem controller now actuates a servo motor (1-14). The servo motor turns a shaft that moves both robotic arms, causing the pantograph to be lowered to the ground. The pantograph intersects the power-strip and the positive and negative contacts in a pantograph contact-pair each touch separate power-strip contacts.

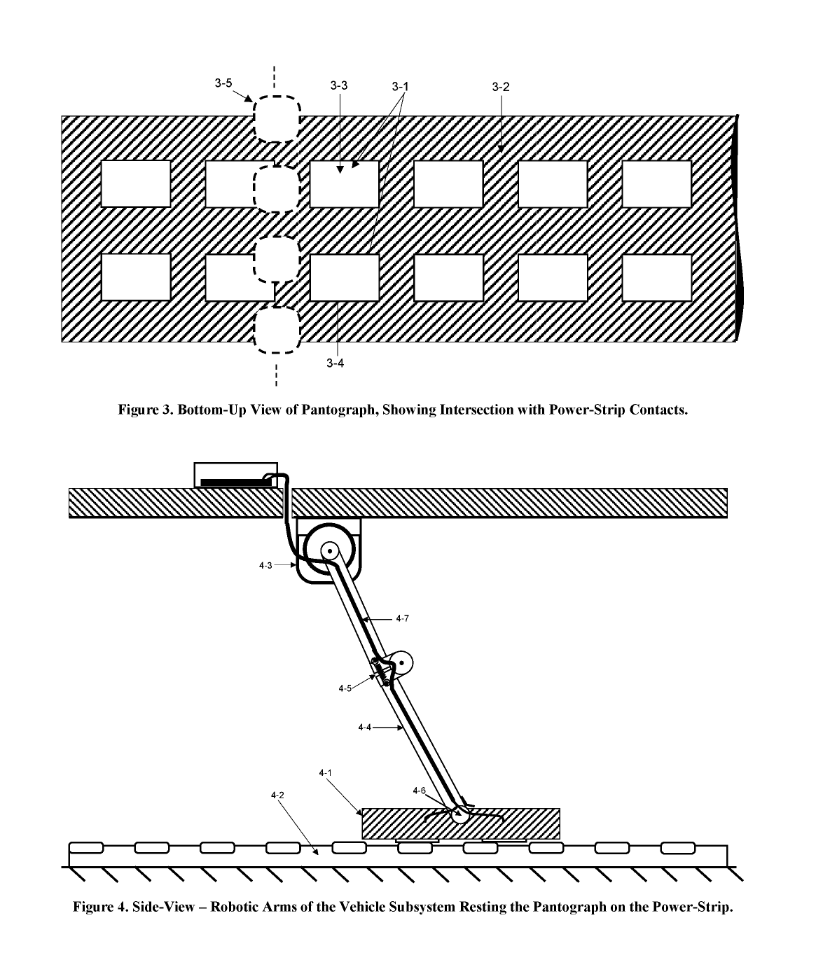

FIG. 2 shows a cross-sectional view of the bottom of the vehicle and the pantograph (2-1) resting on the power-strip (2-2). The rectangles (2-3) enclose the possible area within which the pantograph and the power-strip may intersect. The rectangle (2-4) shows the corresponding allowable area within which the vehicle may be parked while still achieving intersection of the pantograph and the power-strip. Also shown, is how a single servo motor (2-5) uses the shaft (2-6) to lower the robotic arms on each end of the pantograph.

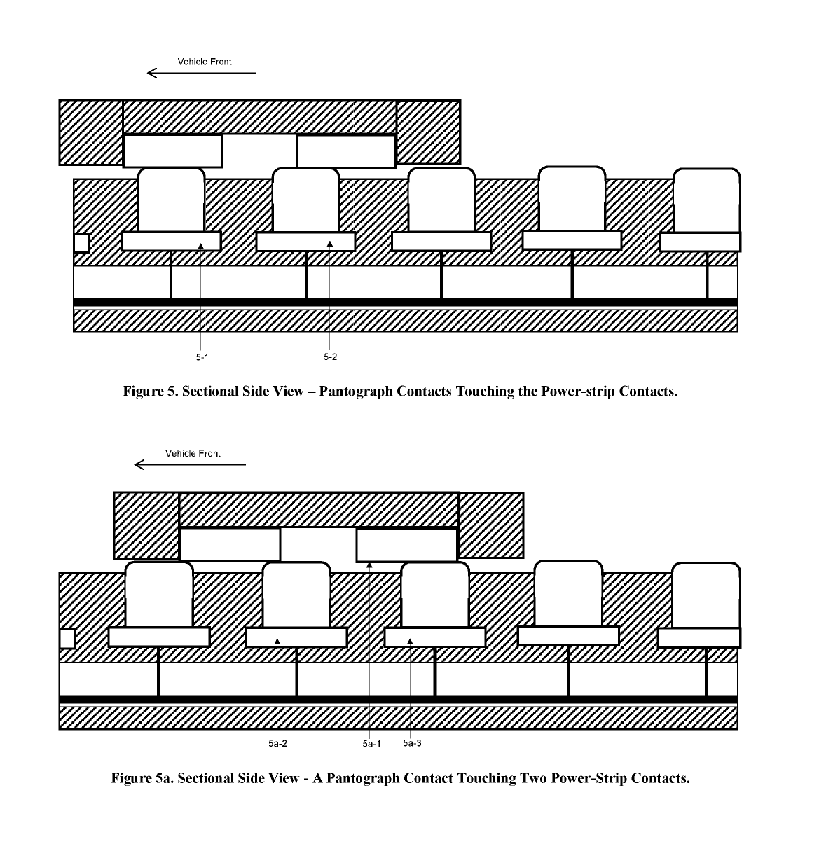

FIG. 3 shows a view of the bottom of the pantograph, with an end-view of the pantograph shown on the left. Each pantograph contact-pair (3-1) is embedded into the insulated backing (3-2). Each contact-pair consists of a positive pantograph contact (3-3) and a negative pantograph contact (3-4). The positions of a line of power-strip contacts (3-5) is also shown, to illustrate how the pantograph contacts might rest on the intersecting power-strip contacts. The gap between pantograph contact-pairs is smaller than the width of each power-strip contact, so that the line of power-strip contacts is guaranteed to touch one or two pantograph contact-pairs.

The reason for having discrete pantograph contact-pairs, as opposed to two long pantograph contacts, is to guard against the possibility that, while the pantograph is receiving charging voltage at the points where it intersects the power-strip, another part of the pantograph may be touching the ground, if the ground happens to be uneven. The electronics within the pantograph normally keeps each contact-pair isolated from the battery-charging circuit of the vehicle. Only when a contact-pair receives charging voltage, by virtue of touching power-strip contacts, does the pantograph connect the contact-pair to the battery-charging circuit of the vehicle. This way, the remainder of the pantograph contact-pairs remain isolated from the power voltage provided to the vehicle's battery-charging circuit, and, should they be touching the ground, cause no harm.

The insulated backing extends significantly on either side of each contact-pair. This ensures that any power-strip contacts made live during the process of charging are completely covered by the insulated backing, and are therefore safe from being accidentally touched by a human or animal nearby. FIG. 4 shows a close-up side view of the pantograph (4-1), as it makes contact with the power-strip (4-2). The servo motor (4-3) turns the robotic arm (4-4) at each end, raising and lowering the pantograph. The servo is equipped with a brake that is actuated when the motor is receiving no current. Hence, the servo (and the robotic arms) remain locked at their last position. Normally, the robotic arms and the pantograph are retracted underneath the vehicle. When triggered to make contact for charging, the vehicle subsystem microprocessor provides current to the servo to lower the robotic arms and the pantograph to the ground. The servo stops at a point that causes the robotic arms and the pantograph at their ends to exert some downward pressure on the power-strip. This ensures good electrical contact. The joint and spring arrangement (4-5) creates this pressure. The hinge (4-6) allows the angle of the pantograph to self-adjust, so that the pantograph stays parallel to the power-strip. The wire (4-7) carries charging current back to the vehicle subsystem, and thence to the vehicle's battery-charging circuit.

FIG. 5 and FIG. 5a are sectional views that show the different positions in which the pantograph contacts may touch the power-strip contacts. The width and spacing of the contacts conform to the following constraint: Each pantograph contact is wider than the gap between two power-strip contacts. This ensures that a pantograph contact touches at least one power-strip contact (5-1, 5-2). The corollary to this is that a pantograph contact may simultaneously touch two power-strip contacts. This is illustrated in FIG. 5a, where the pantograph contact (5a-1) shorts the two power-strip contacts (5a-2) and (5a-3). However, the end result is that in any position the two pantograph contacts touch at minimum two different power-strip contacts.

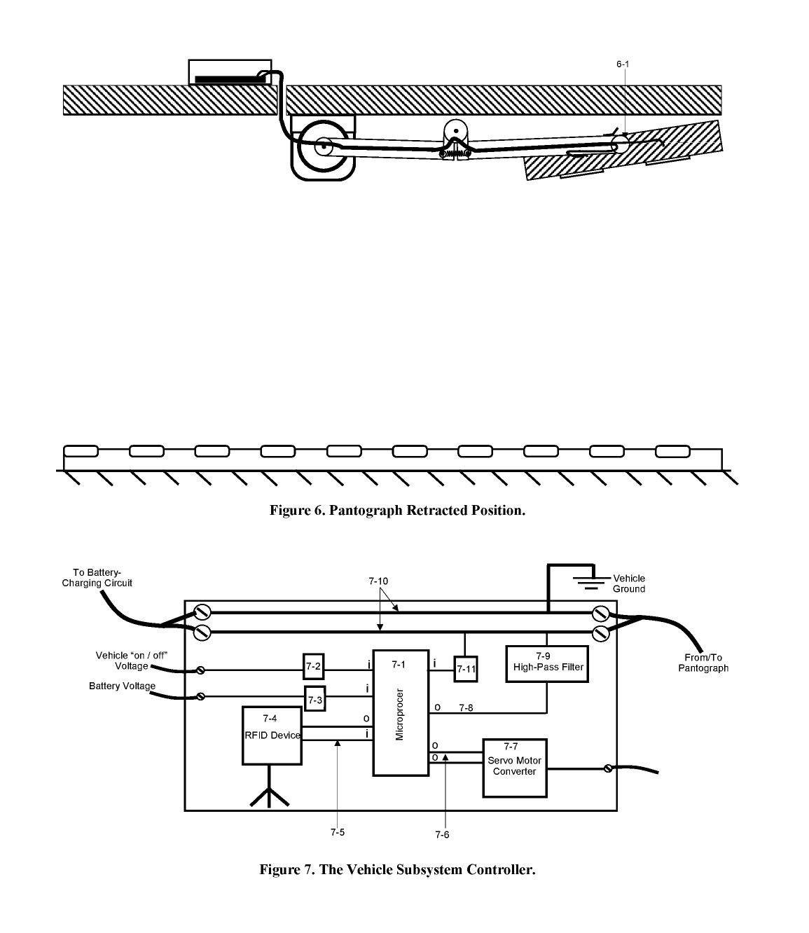

FIG. 6 shows the pantograph in its retracted position. The hinge (6-1) serves the additional purpose of allowing the pantograph to be tucked neatly underneath the vehicle.

FIG. 7 shows an overview of the vehicle subsystem controller. To simplify the figure, the power supply for the digital components and associated circuitry are omitted. The microprocessor (7-1) controls all aspects of the vehicle subsystem. The digital inputs to the microprocessor are marked with an ‘i’ and the digital outputs are marked with an ‘o’.

A primary input to the microprocessor is an indication of the vehicle power “on”/“off” status. The detector (7-2) provides this. Similarly, the detector (7-3) indicates to the microprocessor whether the vehicle battery is fully charged, or not. The RFID device (7-4) is actuated by a digital output from the microprocessor. When this goes high, the RFID device sends out the wireless request signal repeatedly. If the RFID device hears a response from the power source subsystem, it sends a bit-pulse digital input (7-5) to the microprocessor. The pair of digital outputs (7-6) actuate the converter (7-7) that provides forward and reverse power to the servo, to respectively raise and lower the pantograph. When no power is provided to the servo, it locks in its present position with the help of a brake.

The digital output (7-8) from the microprocessor provides the wired request signal. This passes through a high-pass filter (7-9) to the power leads (7-10) going to the pantograph. The wired request signal is a low-voltage, high-frequency carrier, carrying a communications digital bit-stream. The high-pass filter ensures that the AC or DC power voltages from the pantograph are blocked from the electronics on the circuit board. But the wired request signal passes through, and is presented in turn to each pantograph contact. The wired request signal supports a simple protocol whereby the vehicle subsystem authenticates itself to the power source subsystem, using a password. In response, the power source subsystem generates a one-time private key, which it provides to the vehicle subsystem. The vehicle subsystem must transmit this key over and over again to the power source subsystem through the entire period of charging. The power source subsystem only supplies a charging voltage as long as it can verify the key. As soon as the key-verification fails, the power source subsystem disconnects all its contacts from any charging voltage.

The owner's password is stored in flash memory in the microprocessor and may be set by the owner from within the vehicle by an input device, such as a liquid crystal display and keyboard.

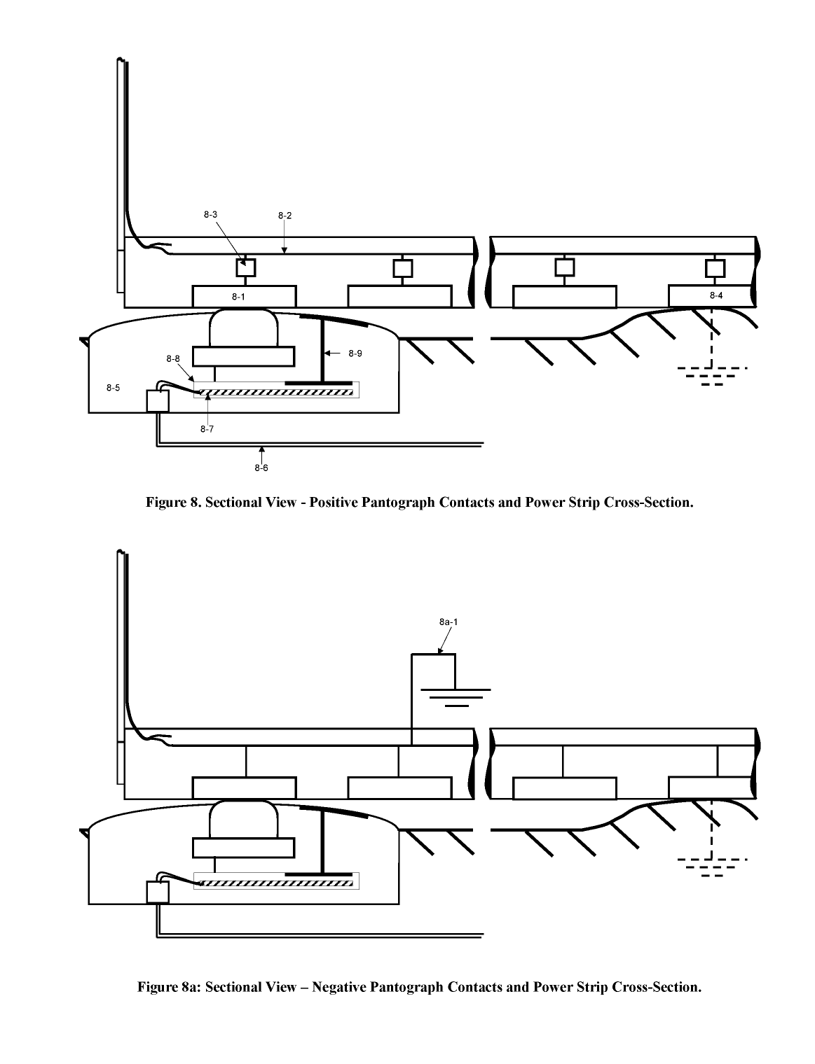

FIG. 8 shows a cross-sectional view of the pantograph, with a positive pantograph touching a power-strip contact.

Each positive pantograph contact (8-1) is connected to the positive lead of the battery-charging circuit (8-2) through an integrated circuit (IC) (8-3). The IC contains a thyristor capable of connecting a DC charging voltage from the power strip contact to the battery-charging circuit of the vehicle. The thyristor is open in its normal state, disconnecting the positive pantograph contact from the positive lead of the battery-charging circuit. When the positive pantograph contact receives a power voltage from the power strip contact, the IC (8-3) causes it's thyristor to close, providing the charging voltage to the battery-charging circuit of the vehicle. The remaining contacts stay disconnected from the battery-charging circuit. If, by chance, another positive pantograph contact (8-4) is touching the ground, it remains disconnected from the battery-charging circuit.

In addition, the IC (8-3) has a band-pass filter, which lets through a high-frequency communication signal between the vehicle and the power strip, even while the thyristor is open. The vehicle uses this communication signal to initially request power from the power strip.

FIG. 8 also shows a cross-sectional view of the power strip, which is mostly made up of an insulating material, such as cement (8-5), capable of withstanding the compression force of a vehicle's wheel riding over it. Power is supplied to the power-strip via an underground cable (8-6). The power-strip circuit board (8-7) is housed in a hollow chamber (8-8). Heat from the circuit board is vented to the outside via the metal heat conductor (8-9). To allow access to the circuit board for maintenance, the power-strip casing includes an access panel (not shown in FIG. 8), which is normally kept locked by a standard lock and key.

FIG. 8a shows a cross-sectional view of a negative pantograph contact touching a power strip contact (different from the one in FIG. 8a). The negative pantograph contact is simply connected to the vehicle ground (8a).

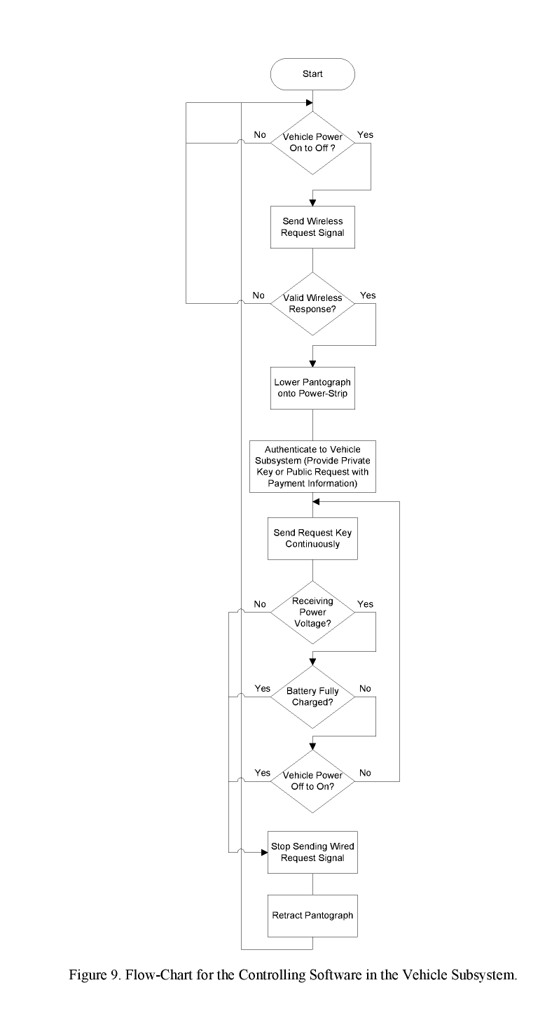

The flow-chart in FIG. 9 illustrates the algorithm of the microprocessor control software in the vehicle subsystem.

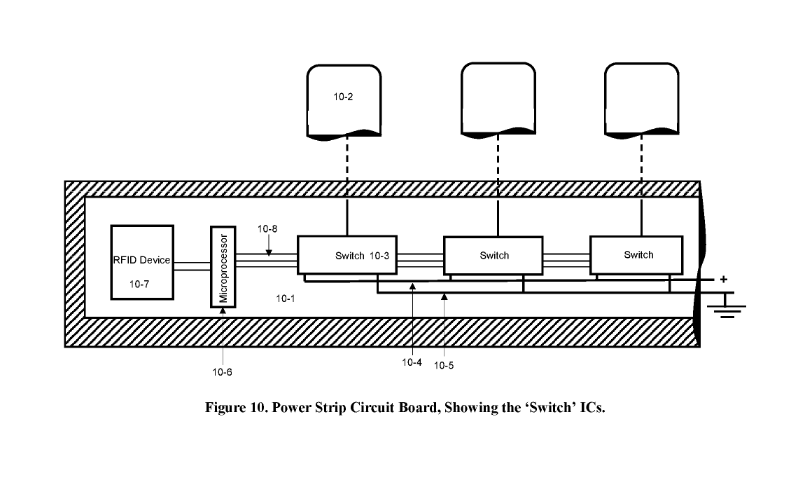

FIG. 10 shows a sectional view of the power-strip, illustrating the circuit board (10-1), housed in a hollow chamber inside the power-strip casing. Each power-strip contact (10-2) is supported by an IC called a ‘switch’ (10-3). The switch has leads on one side connecting to the positive and negative power source leads (10-4 and 10-5), brought to the power-strip by an underground cable. The switch contains thyristors that are capable of creating a connection between its contact and either the positive or negative power source lead.

The power-strip as a whole is controlled by the microprocessor (10-6). Among other things, it controls the RFID device (10-7). A digital input from the device alerts the microprocessor to the fact that it has received a wireless request signal from a vehicle subsystem. The microprocessor uses a digital output to send out the wireless response.

In addition, the microprocessor controls each switch via a common bus (10-8). When the microprocessor receives the wireless request signal from the vehicle subsystem, it commands each switch in turn to test whether it is receiving the wired request signal from its contact. Because of their physical dimensions, one or two contacts receive the wired request signal (see FIG. 5 and FIG. 5a). These are identified by the microprocessor as being ‘positive’. The remaining contacts are identified as being ‘negative’. The microprocessor commands a switch with a positive contact to connect the contact to the positive power source lead (10-4), hence providing the contact with the vehicle charging voltage. If a second positive contact exists, the microprocessor allows it to float; that is, be disconnected. The microprocessor commands the switches of the remaining contacts, identified as being negative, to connect their contacts to power source ground (10-5).

A switch only keeps a positive contact connected to a charging voltage as long as it is continuously receiving the wired request signal from the vehicle. As soon as the wired request signal reception stops, the switch infers that the pantograph is no longer touching the power strip, and breaks the connection.

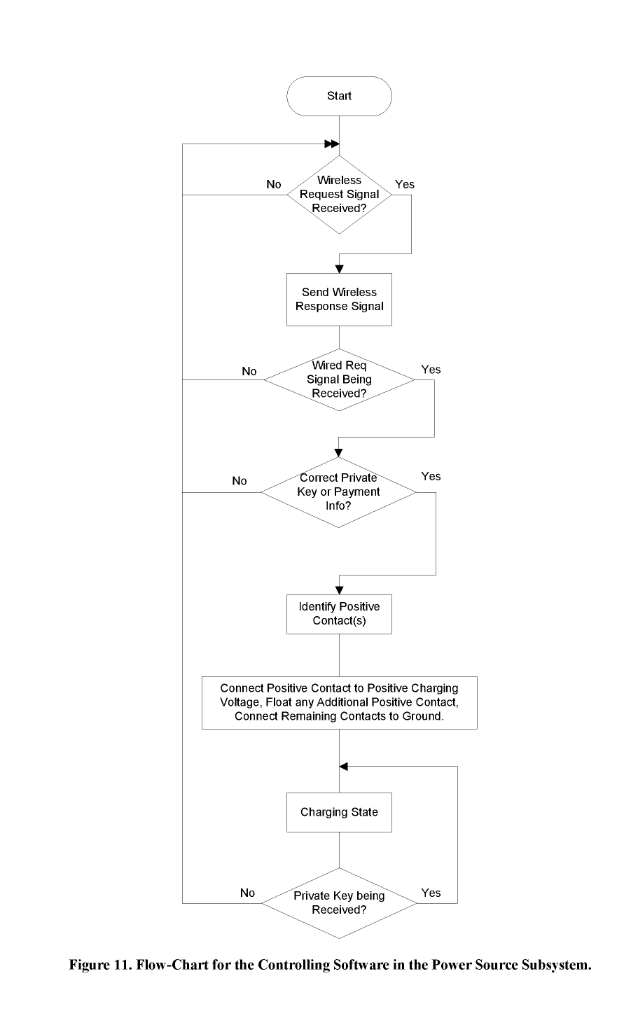

FIG. 11 is a flow-chart, illustrating the algorithm for the control software in the power-strip microprocessor.

As deployment of the system spreads, it may be useful to have designated parking spots in public places such as malls and commuter parking lots. An optional feature of the system is the ability of the power source subsystem to sell power to the vehicle subsystem with the use of a credit card. In this case, the protocol supported by the wired request signal is enhanced to allow the vehicle subsystem to provide the owner's credit card information to the power source subsystem. To support this feature the power source subsystem is connected to the internet. An application on the internet verifies the owner's credit card information and performs subsequent billing for the electric charge provided. The owner's credit card information may be entered on a one-time basis into the vehicle subsystem microprocessor and stored in flash memory.

The cross-sectional view of the power-strip in FIG. 8 illustrates its ability to withstand weather effects. The power-strip casing (8-7) and the underground power supply cable (8-8) are sealed and water-proofed. The power-strip alters the physical structure of an ordinary parking spot minimally, in that it rises above the surface no more than a ½ inch, and has the appearance of a small, rounded speed-bump. If the designated parking spot is under water, it is unlikely that the wireless request signal and the wireless response can get through. In the event that these signals do get through (possibly, if the depth of the water is very small) and the pantograph is lowered into the water, the wired request signal from each pantograph contact is shorted by the water. As a result, no power voltage is supplied to any of the contacts of the power-strip. After a timeout period, the vehicle subsystem microprocessor retracts the pantograph and abandons any further attempt to acquire power. Once the designated parking spot is drained of the flood water, the system functions normally as before.

### Alternate Embodiments

I have described above a set of ideas that enable the system to satisfy the constraints of being automatic and transparent, minimally affecting the physical infrastructure of parking spots, being efficient in transporting power, being safe from electric shock, being low-cost and being weather-proof. By combining a subset of the ideas with other techniques in systems where some of the constraints have been relaxed, a number of alternate embodiments can be realized.

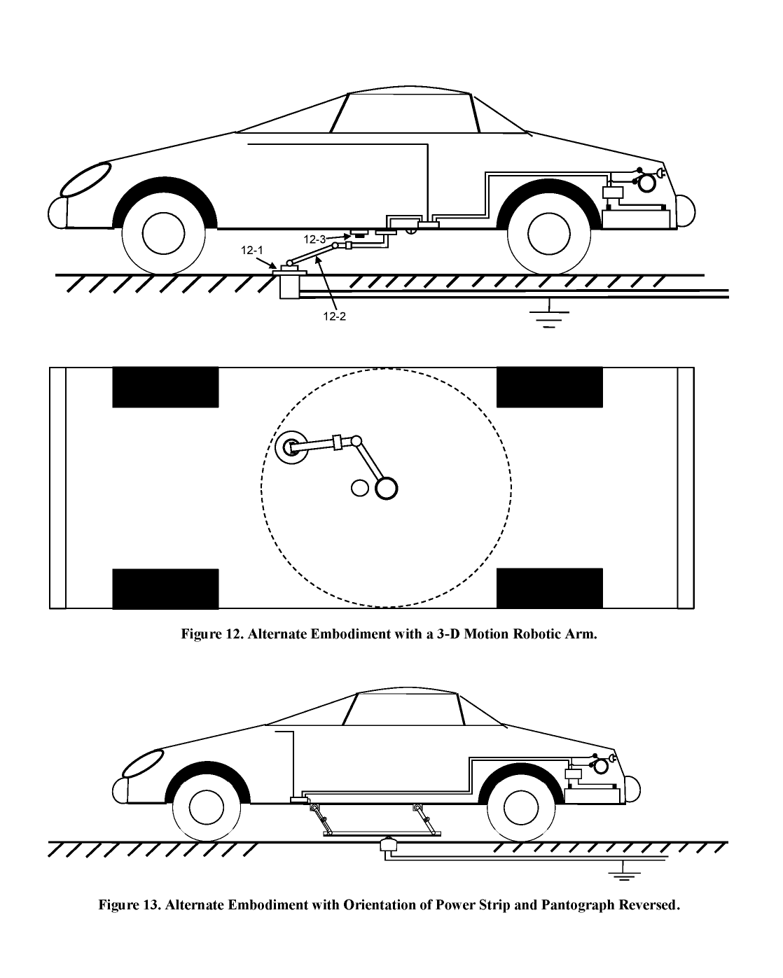

For example, FIG. 12 shows an alternate embodiment involving a typical robotic arm and sensor inputs, with computer-based image analysis to position the arm. The pantograph is replaced with just one contact-pair (12-1) at the tip of a robotic arm (12-2) in the vehicle subsystem. The robotic arm now has to be positioned by 3 servo motors to home in on the contact pair. An optical or infra-red sensing system (12-3) could provide the necessary inputs to guide the arm. The idea of contact lines at right angles to each other is not used. However, the other ideas presented, e.g. embedding the power source subsystem into the ground to obviate a vertical structure that might impede the driver, using a wireless request signal with commonly-available RFID devices to trigger initial homing of the arm, a wired request signal to enable safety, and using the same signal to carry credit card information, could continue to be present in this embodiment and in numerous variations thereof.

FIG. 13 shows an alternate embodiment where the pantograph is suspended parallel to the length of the vehicle and the power-strip is arranged parallel to the width of the vehicle. It continues to use the key idea of embedding the power-source subsystem into the ground so as not to alter the configuration of the parking spot, and of minimizing moving parts and robotics complexity by having two lines of contacts at right-angles to each other, touching where they intersect and completing a charging circuit.

The following is claimed:

1. A system for automatically connecting a parked vehicle to a power source, consisting of two subsystems, a ‘vehicle subsystem’ in a vehicle, and a ‘power source subsystem’ in a designated parking spot,
wherein the system requires the driver to take no action that is different from parking an unequipped vehicle in an ordinary parking spot, that is, the driver needs only to stop the vehicle arbitrarily within the confines of the spot and turn the vehicle's main power switch off,
in order to cause the system to automatically accomplish the task of connecting a pair of battery-charging contacts from the vehicle to a pair of power-providing contacts from the power source subsystem.

2. The system according to claim 1,
wherein the power source subsystem does not cause the designated parking spot to be physically different from an ordinary parking spot,
being almost-flush with the ground, creating no vertical structures that may obstruct the driver in maneuvering the vehicle in and around the spot, nor creating any dips in the ground that may be prone to collecting water,
the power source contacts, being safe in their non-charging state when touched by a human or animal, having no voltage on them at all, and being likewise safe in their ‘live’ or charging state, being completely covered by the insulated backing of the charging apparatus of the vehicle subsystem.

3. The system according to claim 1, whereby the vehicle subsystem:
is triggered to attempt to make the electrical connection when the vehicle's motor power is turned from the “on” to the “off” state after it is parked, and
is triggered to break the electrical connection when the vehicle's battery is fully charged, or when the vehicle's motor power is turned from the “off” to the “on” state.

4. The system according to claim 1, where:
on being triggered to attempt to make an electrical connection, the vehicle subsystem sends out a wireless request signal from a radio-frequency identification device (RFID) contained in it, and, on receiving a wireless response from a RFID device contained in the power source, determines that the vehicle is in a designated parking spot, and,
on receiving a wireless request signal, the power source subsystem determines that a vehicle subsystem is attempting to connect to it.

5. The system according to claim 1, wherein the vehicle subsystem connects its charging contacts to the contacts of the power source subsystem while allowing the driver to park in any position within the confines of the parking spot, subject to the constraint that the length axis of the vehicle is approximately aligned with the length axis of the parking spot, without any special docking or driving maneuvers and without taking any additional physical action to connect the vehicle charging contacts to the power source, using a system comprising:
a ‘pantograph’, consisting of a stiff, insulated backing, along which are supported a series of contact-pairs, oriented such that the line joining the contacts in each pair is at right angles to the length axis of the pantograph,
the pantograph being supported at the end of one or two stiff arms and being capable of being lowered by motor control towards the ground,
a ‘power-strip’, almost flush with the ground, consisting of a line of discrete contacts aligned with its length axis, where the power strip is oriented at right angles to the pantograph, when the vehicle is parked in the designated parking spot,
said lowering of the pantograph towards the ground causing it to touch the power-strip at some point of intersection,
enabling each of the contacts in a pantograph contact-pair to touch at least one separate power-strip contact, this being ensured by the shapes and dimensions of the contacts, where,
each pantograph contact is wider than the gap between two power-strip contacts,
and each power-strip contact is narrower than the gap between two pantograph contacts.

6. The method according to claim 5, wherein the electronics within the vehicle subsystem and the power source subsystem together complete a battery-charging circuit for the vehicle by:
the vehicle subsystem sending a low-voltage, high-frequency communication signal, termed a ‘wired request signal’, through each of the ‘positive’ pantograph contacts, where a positive contact is the one in a contact pair that may potentially carry a charging voltage, the other contact being termed the ‘negative’ contact,
the circuit for such a signal being completed by means of a band-pass filter connecting each pair of successive power-strip contacts,
a microprocessor within the power source subsystem using the reception of the wired request signal via a hardware interface to identify the two power strip contacts, each of which is touching a separate contact in a pantograph contact-pair,
the microprocessor authenticating the vehicle requesting the charge by means of data carried over the wired request signal,
and, subsequently, the microprocessor using electronics within the power-strip to connect one of the touching power-strip contacts to an AC ‘live’ or DC positive charging voltage, and connecting the other touching power-strip contact to ground,
the vehicle subsystem, on sensing a charging voltage on one contact in a contact-pair, connects this contact to the positive lead of the vehicle battery charging circuit, while connecting the other contact in the pair to ground.

7. The system according to claim 1 and the method according to claim 5, wherein the power source subsystem authenticates the vehicle's charging request via data encoded over the wired request signal,
verifying a password or a private key, in the event that the power source subsystem is designated to support electrical charging for a single vehicle,
or verifying a publicly-known request accompanied by payment information, such as the owner's credit card information, in the event that the designated parking spot is public and is capable of selling power to any appropriately-equipped vehicle.

8. The system according to claim 1 and the method according to claim 5, wherein the system is made safe from accidentally shocking a person or animal with a live contact by the power-strip electronics ensuring that a power-strip contact only provides a positive charging voltage when it is touching a pantograph contact, at which time it is completely shielded from the rest of the world by the insulated backing of the pantograph, this being ensured by:
incorporating into the power-strip electronics the functionality that a power-strip contact remains connected to a positive charging voltage after authentication, only as long as it continues to receive a public or private key over the wired request signal,
the connection being actively broken as soon as the power source subsystem detects that the request key is not being received.

9. The system according to claim 1 and the method according to claim 5, wherein:
the heat generated by the power-strip electronics is vented from the cavity in the power-strip containing the electronics to the outside world, while allowing the power-strip to remain water-proof, by means of a heat exchanger comprising:
a plate made of a heat-conductive material lining a significant surface area of the roof or walls of the cavity,
a plate of the same heat-conductive material lining a significant surface area of the outer casing of the power-strip,
and a heat conductive path made of the same material connecting the inner plate to the outer plate through the power-strip casing,
there being no gap between the heat-conducting path and the power-strip casing material, rendering the casing, as a whole, water-proof.
